(19) United States
(12) Patent Application Publication
(10) Pub. No.: US 2023/0184675 A1
(43) Pub. Date: Jun. 15, 2023

(54) TURBIDIMETER AND TURBIDITY MEASUREMENT METHOD

(71) Applicant: Yokogawa Electric Corporation, Tokyo (JP)

(72) Inventor: Toshihiko KYAKUNO, Tokyo (JP)

(21) Appl. No.: 18/064,584

(22) Filed: Dec. 12, 2022

(30) Foreign Application Priority Data
Dec. 14, 2021 (JP) 2021-202848

(51) Int. Cl. G01N 21/47; G01N 21/59

(52) U.S. Cl. CPC G01N 21/47; G01N 21/59; G01N 2021/1734

(57) ABSTRACT

A turbidimeter (1) according to the present disclosure is for measuring turbidity of an object to be measured (S) and includes a light source (21) that irradiates an irradiation light (L1) towards the object to be measured (S), a light receiver (22) including a solid-state image sensor (222) that outputs a detection signal of light to be measured (L2) that includes transmitted light (L21) and scattered light (L22) based on the irradiation light (L1) irradiated towards the object to be measured (S), and a controller (31) that calculates a spatial distribution (D) of intensity of the light to be measured (L2) on a light-receiving surface (A) of the solid-state image sensor (222) based on a detection signal of the light to be measured (L2) and calculates the turbidity based on the calculated spatial distribution (D).

### CROSS-REFERENCE TO RELATED APPLICATION

The present application claims priority to Japanese Patent Application No. 2021-202848 filed on Dec. 14, 2021, the entire contents of which are incorporated herein by reference.

### TECHNICAL FIELD

The present disclosure relates to a turbidimeter and a turbidity measurement method.

### BACKGROUND

Technology relating to a turbidimeter for measuring the degree of turbidity of an object to be measured, such as water, is known.

For example, patent literature (PTL) 1 discloses a turbidimeter capable of accurate measurement by maintaining linearity over a wide range, from areas of low to high concentration of suspended matter in the object to be measured, by means of identical cell length and suitable detector arrangement.

### CITATION LIST

### Patent Literature

PTL 1: JP 2006-329629 A

### SUMMARY

A turbidimeter according to some embodiments is a turbidimeter for measuring turbidity of an object to be measured, the turbidimeter including a light source configured to irradiate an irradiation light towards the object to be measured; a light receiver including a solid-state image sensor configured to output a detection signal of light to be measured that includes transmitted light and scattered light based on the irradiation light irradiated towards the object to be measured; and a controller configured to calculate a spatial distribution of intensity of the light to be measured on a light-receiving surface of the solid-state image sensor based on a detection signal of the light to be measured and calculate the turbidity based on the calculated spatial distribution.

### BRIEF DESCRIPTION OF THE DRAWINGS

In the accompanying drawings:

FIG. 1 is a functional block diagram illustrating the schematic configuration of a turbidimeter according to an embodiment of the present disclosure;

FIG. 2 is a schematic diagram illustrating the configuration of the optical module in FIG. 1;

FIG. 3 is a schematic diagram illustrating a first example of a turbidity calculation process by the controller in FIG. 1;

FIG. 4 is a schematic diagram illustrating a second example of a turbidity calculation process by the controller in FIG. 1;

FIG. 5 is a first schematic diagram illustrating a first example of an additional process by the controller in FIG. 1;

FIG. 6 is a second schematic diagram illustrating the first example of an additional process by the controller in FIG. 1; and

FIG. 7 is a flowchart illustrating a second example of an additional process by the controller in FIG. 1.

### DETAILED DESCRIPTION

Scattered light based on irradiation light that is irradiated towards an object to be measured typically has a spatial distribution of intensity on the light-receiving surface of the light receiver. In other words, the scattered light spreads continuously on the light-receiving surface. On the other hand, in conventional turbidimeters such as those described in PTL 1, a plurality of scattered light detectors configuring the light receiver are discretely arranged on the light-receiving surface. Therefore, it is difficult to detect all of the continuously spread scattered light, leading to a low accuracy in turbidity measurement.

It would be helpful to provide a turbidimeter and a turbidity measurement method capable of improving the accuracy of turbidity measurement.

A turbidimeter according to some embodiments is a turbidimeter for measuring turbidity of an object to be measured, the turbidimeter including a light source configured to irradiate an irradiation light towards the object to be measured; a light receiver including a solid-state image sensor configured to output a detection signal of light to be measured that includes transmitted light and scattered light based on the irradiation light irradiated towards the object to be measured; and a controller configured to calculate a spatial distribution of intensity of the light to be measured on a light-receiving surface of the solid-state image sensor based on a detection signal of the light to be measured and calculate the turbidity based on the calculated spatial distribution.

This configuration can improve the accuracy of turbidity measurement. By the light receiver including a solid-state image sensor, the turbidimeter can perform turbidity measurements using the equivalent of tens of thousands to millions or more of light-receiving elements as compared to conventional turbidimeters that have transmitted light detectors and scattered light detectors discretely arranged and that use only several light-receiving elements. Since the gap between light-receiving elements is extremely reduced in the turbidimeter, the percentage of light to be measured that is directed to the gap between light-receiving elements and not detected is greatly reduced. In other words, it is possible to detect substantially all of the light to be measured that is continuously spread out. The turbidimeter can accurately calculate the spatial distribution of the intensity of the light to be measured on the light-receiving surface of the solid-state image sensor. Consequently, the turbidimeter can perform more accurate turbidity measurements.

In an embodiment, the controller may be configured to calculate the turbidity based on a width of the spatial distribution. This enables the turbidimeter to measure turbidity while using all of the detection information on the light to be measured that spreads out on the light-receiving surface. Accordingly, the turbidimeter can perform more accurate turbidity measurements.

In an embodiment, the controller may be configured to calculate a ratio of detected signal intensity of the scattered light to detected signal intensity of the transmitted light based on at least one first region in which the scattered light is detected in the spatial distribution and a second region in which the transmitted light is detected in the spatial distribution. This enables the turbidimeter also to calculate turbidity in the same way as a conventional turbidimeter. Accordingly, the user can easily compare the results of turbidity measurements using the turbidimeter with the results of turbidity measurements using a conventional turbidimeter, such as one that discretely detects the light to be measured using several light-receiving elements.

In an embodiment, the light receiver may include a lens system that includes at least one first lens and directs the light to be measured to the solid-state image sensor. This enables the turbidimeter to guide the light to be measured, which is diffused from the object to be measured and incident on the light receiver, to the solid-state image sensor without leakage. In addition, with the lens system, the turbidimeter can also provide a focus adjustment function and/or a zoom function to a camera module as the light receiver.

In an embodiment, the light source may include a second lens that directs the irradiation light to a region in which the object to be measured is located through a measurement window separating the region from outside space and that collimates the irradiation light, and the controller may be configured to control the lens system to focus on a surface of the second lens on a side by the object to be measured, an outer surface or inner surface of the measurement window, or an interior of the object to be measured. This enables the turbidimeter to capture different events using a focus adjustment function of a camera module. By viewing images focused on various locations, users can observe the event that meets their objective. Users can observe each event in real time based on images outputted by real-time imaging.

In an embodiment, the controller may be configured to control the lens system to enlarge the spatial distribution when the spatial distribution is smaller than the light-receiving surface. This enables the turbidimeter always to detect the light to be measured with maximum resolution using a magnification function of a camera module. Accordingly, the turbidimeter can further improve the accuracy of turbidity measurement.

In an embodiment, the controller may be configured to control the lens system to reduce the spatial distribution when the spatial distribution is larger than the light-receiving surface. This enables the turbidimeter always to detect the light to be measured with maximum resolution using a reduction function of a camera module. Accordingly, the turbidimeter can further improve the accuracy of turbidity measurement.

In an embodiment, the light receiver may include a light source configured to illuminate an object to be imaged by the solid-state image sensor with light. This enables the turbidimeter also to cause the light source to function as a strobe light source for a camera. Accordingly, the turbidimeter can also use the light source on the light receiver side to increase the amount of light in a case in which the amount of light of the light source on the light source side is insufficient during image capture by a camera module as the light receiver. Similarly, the turbidimeter can also use the light source on the light receiver side to improve visibility in backlight.

In an embodiment, the solid-state image sensor may include a color CCD. This enables the turbidimeter to measure not only the turbidity of the object to be measured but also its chromaticity.

A turbidity measurement method according to some embodiments is a turbidity measurement method for measuring turbidity of an object to be measured and includes irradiating an irradiation light towards the object to be measured; using a solid-state image sensor to detect light to be measured that includes transmitted light and scattered light based on the irradiation light irradiated towards the object to be measured; calculating a spatial distribution of intensity of the light to be measured on a light-receiving surface of the solid-state image sensor based on a detection signal of the light to be measured; and calculating the turbidity based on the calculated spatial distribution.

This configuration can improve the accuracy of turbidity measurement. By the light receiver including a solid-state image sensor, the turbidimeter that performs the turbidity measurement method can perform turbidity measurements using the equivalent of tens of thousands to millions or more of light-receiving elements as compared to conventional turbidimeters that have transmitted light detectors and scattered light detectors discretely arranged and that use only several light-receiving elements. Since the gap between light-receiving elements is extremely reduced in the turbidimeter, the percentage of light to be measured that is directed to the gap between light-receiving elements and not detected is greatly reduced. In other words, it is possible to detect substantially all of the light to be measured that is continuously spread out. The turbidimeter can accurately calculate the spatial distribution of the intensity of the light to be measured on the light-receiving surface of the solid-state image sensor. Consequently, the turbidimeter can perform more accurate turbidity measurements.

According to the present disclosure, a turbidimeter and a turbidity measurement method capable of improving the accuracy of turbidity measurement can be provided.

The turbidity of an object to be measured as measured by a turbidimeter is determined by the amount of particles, i.e., suspended matter, present in the object to be measured. Various methods are known for measuring the amount of suspended matter. For example, the absorption and scattering of irradiation light by suspended matter in the object to be measured are used in a turbidimeter based on a transmitted/scattered light comparison method. When irradiation light is irradiated onto an object to be measured that includes suspended matter, the transmitted light is absorbed by particles and weakens as the turbidity is higher. The scattered light, on the other hand, is scattered by particles and strengthens as the turbidity is higher.

The intensity of transmitted light changes logarithmically by the Beer-Lambert law and becomes extremely weak in a highly turbid liquid. Accordingly, it is difficult to measure a highly turbid object to be measured using only transmitted light. Scattered light is theoretically proportional to turbidity, but during actual measurement, scattered light is affected by absorption in a highly turbid object to be measured. Consequently, the detection signal intensity related to the scattered light is not proportional to turbidity. A turbidimeter based on a transmitted/scattered light comparison method therefore uses the value yielded by dividing the detection signal intensity of scattered light by the detection signal intensity of transmitted light, and a monotonically increasing function between the detection signal value and the turbidity is established.

As illustrated in PTL 1, for example, a known turbidimeter includes a lamp light source, a condensing lens, a liquid tank configured by transparent glass, a transmitted light detector for detecting transmitted light, and a plurality of scattered light detectors for detecting scattered light. White light irradiated from the lamp light source is collimated by the condensing lens. The collimated white light is then incident on liquid to be measured that is flowing in the liquid tank. The edges of the liquid tank are partitioned by transparent glass. For example, a portion of the collimated light is scattered by suspended matter in the liquid to be measured flowing in the liquid tank from bottom to top. The scattered light is detected by a scattered light detector positioned downstream from the liquid tank. The transmitted light that is not scattered but rather transmitted is detected by a transmitted light detector similarly positioned downstream from the liquid tank. A turbidity N of the liquid to be measured is calculated with Equation 1 below by an arithmetic circuit or the like, using the detection signal intensities of the detected transmitted light and the detected scattered light.

$$\frac{{I}_{S}}{{I}_{T}} = \frac{{I}_{S} ( 0 )}{{I}_{T} ( 0 )} + cLN \qquad ( Equation 1 )$$

Here, I_{T} represents the detection signal intensity of transmitted light transmitted by the liquid to be measured, and I_{S} represents the detection signal intensity of scattered light scattered by the liquid to be measured. I_{T}(0) represents the detection signal intensity of transmitted light transmitted by a liquid with 0 degree turbidity, and I_{S}(0) represents the detection signal intensity of scattered light scattered by a liquid with 0 degree turbidity. Furthermore, c is a constant determined by the suspended matter in the liquid to be measured and the shape and characteristics of the detectors, and L is the optical path length of the liquid tank used for measurement. As indicated by Equation 1, the ratio I_{S}/I_{T} changes linearly with respect to the turbidity N.

In conventional turbidimeters, a photodiode (PD) is used as a light-receiving element in detectors including a transmitted light detector and a scattered light detector. The PD of the transmitted light detector is placed at a position opposite the lamp light source across the liquid tank, and a plurality of PDs for the scattered light detector are discretely placed around it. The intensity of transmitted light and the intensity of scattered light are thus measured separately. The turbidimeter calculates the turbidity based on the results of both measurements.

Scattered light based on irradiation light that is irradiated towards an object to be measured, which includes a liquid to be measured or the like, typically has a spatial distribution of intensity on the light-receiving surface of the light receiver. In other words, the scattered light spreads continuously on the light-receiving surface. On the other hand, in conventional turbidimeters such as those described in PTL 1, a plurality of scattered light detectors configuring the light receiver are discretely arranged on the light-receiving surface.

In the case of turbidity measurement using a plurality of discretely arranged PDs, the number of light-receiving elements that detect the light to be measured, which includes transmitted and scattered light and has a normal distribution, is limited. It is difficult to detect the light to be measured that is incident between one PD and another. Therefore, it is difficult to detect all of the continuously spread scattered light, leading to a low accuracy in turbidity measurement. In other words, the original information with a normal distribution becomes discrete, making it difficult to obtain an accurate distribution of the light to be measured. In order to detect all scattered light, it has been necessary to mount PDs on the light-receiving surface without gaps. In addition, PDs can discriminate between light and dark, i.e., the intensity of the light to be measured that includes transmitted light and scattered light, but PDs cannot discriminate the hue.

If condensation forms on the outer surface of the transparent glass configuring the liquid tank, such as the outer surface on the light-receiving side, then the accuracy of the turbidity measurement further decreases. Similarly, if the inner surface of the transparent glass that configures the liquid tank, such as the inner surface located behind the outer surface on the light-receiving side, becomes dirty due to the adhesion of foreign matter in the object to be measured, then the accuracy of the turbidity measurement further decreases.

Supposing the turbidity exhibits an abnormal value due to condensation on the outer surface of the transparent glass and/or a dirty inner surface of the transparent glass, the user and the turbidimeter cannot quickly determine whether the cause is condensation, dirtiness, or both. In other words, the user and the turbidimeter cannot accurately and quickly ascertain the cause of the abnormal turbidity value.

When foreign matter such as a fallen leaf flows through the object to be measured and passes through the optical path forming part of the turbidimeter, the turbidity calculated by the turbidimeter exhibits an instantaneous abnormal value. In such cases as well, the user and the turbidimeter are unable to accurately and quickly ascertain the cause of the instantaneous abnormality in the turbidity value.

It would be helpful to provide a turbidimeter and a turbidity measurement method capable of solving such problems. Embodiments of the present disclosure are mainly described below with reference to the drawings.

(Configuration)

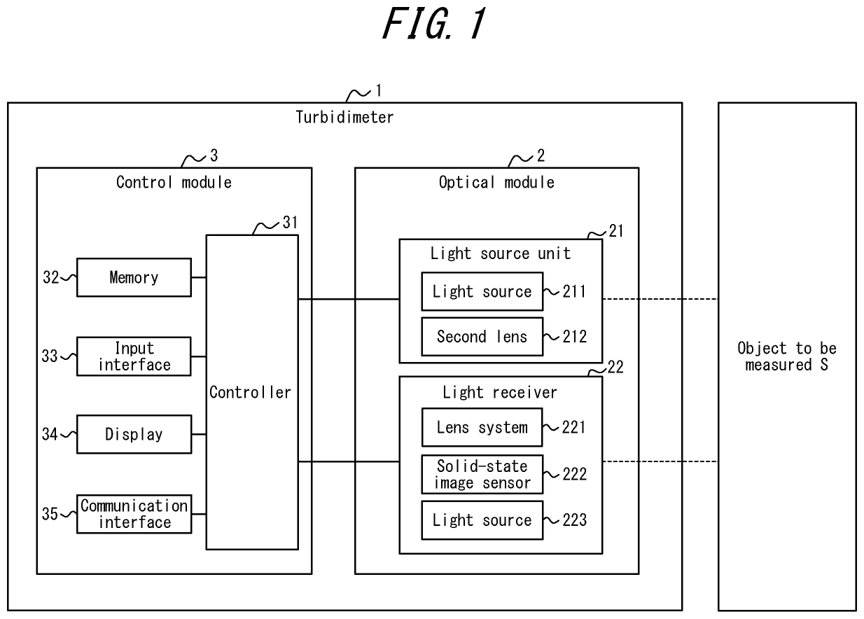

FIG. 1 is a functional block diagram illustrating the schematic configuration of a turbidimeter 1 according to an embodiment of the present disclosure.

The turbidimeter 1 according to an embodiment is, for example, a turbidimeter based on a transmitted/scattered light comparison method. The turbidimeter 1 measures the turbidity of an object to be measured S. In the present disclosure, the “object to be measured S” includes, for example, water, solution, or any other liquid that can be the object of measurement. The major constituent elements of the turbidimeter 1 include an optical module 2 and a control module 3.

The optical module 2 includes a light source unit 21 and a light receiver 22. The light source unit 21 includes a light source 211 and a second lens 212. The light receiver 22 includes a lens system 221, a solid-state image sensor 222, and a light source 223. The light receiver 22 functions as a camera module, for example.

The light source 211 of the light source unit 21 includes a lamp light source, for example. The light source 211 irradiates white light having a broadband emission spectrum in the visible light region as irradiation light. The second lens 212 of the light source unit 21 includes, for example, a condensing lens. The light source unit 21 irradiates the irradiation light, emitted from the light source 211, through the second lens 212 towards the object to be measured S.

The lens system 221 of the light receiver 22 includes at least one first lens. The lens system 221 guides the light to be measured, which includes transmitted light and scattered light based on the irradiation light irradiated towards the object to be measured S, to the solid-state image sensor 222. The lens system 221 includes a drive mechanism for moving at least one first lens, included in the lens system 221, along an optical axis or the like in order for the camera module as the light receiver 22 to have a focus adjustment function and a zoom function.

The solid-state image sensor 222 of the light receiver 22 includes, for example, a Charge Coupled Device (CCD). In other words, the solid-state image sensor 222 is configured by elements, ranging in number from tens of thousands to millions or more, capable of detecting light and integrated on a small chip. The solid-state image sensor 222 outputs a detection signal of the light to be measured based on the irradiation light irradiated toward the object to be measured S. The wavelength band of the solid-state image sensor 222 includes the wavelength bands of the optical spectra of transmitted light and scattered light based on irradiation light irradiated towards the object to be measured S.

The light source 223 of the light receiver 22 includes, for example, a Light Emitting Diode (LED). The light source 223 illuminates the object to be imaged by the solid-state image sensor 222 with light. For example, in a case in which the amount of light of the light source 211 is insufficient during image capture by the camera module as the light receiver 22, a case in which backlight is to be suppressed, or the like, the light source 223 functions as a strobe light source for the camera.

The control module 3 includes a controller 31, a memory 32, an input interface 33, a display 34, and a communication interface 35.

The controller 31 includes one or more processors. The “processor” in an embodiment is a general purpose processor or a dedicated processor specialized for particular processing, but these examples are not limiting. The controller 31 includes a processor capable of processing related to the turbidimeter 1. The controller 31 is communicably connected to each component configuring the turbidimeter 1 and controls and manages operations of the turbidimeter 1 overall, starting with the components thereof.

The controller 31 controls the turning on and turning off of the light source 211 in the light source unit 21. The controller 31 controls the turning on and turning off of the light source 223 in the light receiver 22. The controller 31 acquires a detection signal, of the light to be measured, outputted from the solid-state image sensor 222 of the light receiver 22 and calculates the turbidity of the object to be measured S based on the acquired detection signal. Additionally, the controller 31 calculates parameters necessary for calculating the turbidity of the object to be measured S.

The memory 32 includes any storage module, such as a hard disk drive (HDD), a solid state drive (SSD), an electrically erasable programmable read-only memory (EEPROM), a read-only memory (ROM), or a random access memory (RAM). The memory 32 is not limited to being internal to the turbidimeter 1 and may include an external storage module connected through a digital input/output port, such as universal serial bus (USB). The memory 32 functions as, for example, a main memory, an auxiliary memory, or a cache memory. The memory 32 stores any information necessary for implementing the operations of the turbidimeter 1.

The memory 32 stores detection information based on the detection signal, of the light to be measured, outputted from the light receiver 22. The memory 32 stores information calculated by the controller 31. The memory 32 stores system programs, application programs, and the like.

The input interface 33 includes any input interface that receives input operations by the user of the turbidimeter 1. The input interface 33 receives input operations by the user of the turbidimeter 1 to acquire input information from the user. The input interface 33 outputs the acquired input information to the controller 31. For example, the user uses the input interface 33 to input any information necessary for implementing the operations of the turbidimeter 1.

The display 34 includes any output interface that outputs images. The display 34 includes a liquid crystal display, for example. The display 34 displays various information calculated by the controller 31, for example, to the user of the turbidimeter 1. For example, the display 34 displays settings screens, necessary for the user to input any type of information for implementing the operations of the turbidimeter 1, to the user.

The communication interface 35 includes any communication interface compliant with a suitable wired or wireless communication protocol. The communication interface 35 may transmit various information calculated by the controller 31 to any external apparatus. The communication interface 35 may receive any information necessary for implementing operations of the turbidimeter 1 from any external apparatus. For example, the communication interface 35 may receive a control signal for controlling the optical module 2 from any external apparatus.

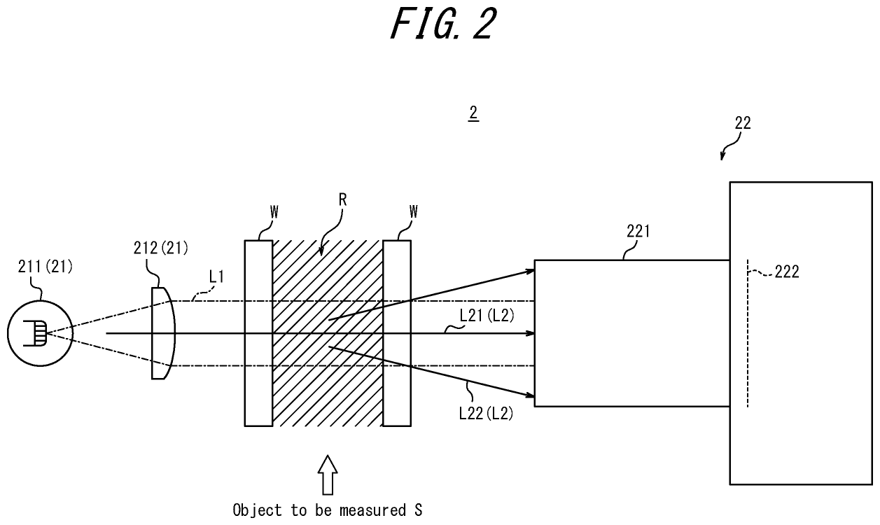

FIG. 2 is a schematic diagram illustrating the configuration of the optical module 2 in FIG. 1. Referring to FIG. 2, the configuration and functions of the optical module 2 are now mainly described.

The light source 211 of the light source unit 21 is located on the opposite side of the light receiver 22 across a region R through which the object to be measured S is flowing, for example from below to above. The second lens 212 of the light source unit 21 guides irradiation light L1 from the light source 211 to the region R by passing through the measurement window W that separates the region R where the object to be measured S is located from outside space. The second lens 212 collimates the irradiation light L1 from the light source 211. The light source unit 21 irradiates the collimated irradiation light L1 towards the object to be measured S. The irradiation light L1 irradiated from the light source unit 21 passes through the measurement window W, enters the region R, and propagates inside the object to be measured S. The measurement window W is made of transparent glass.

Light to be measured L2 is generated based on the irradiation light L1 irradiated towards the object to be measured S. In a case in which the turbidimeter 1 uses a transmitted/scattered light comparison method, the light to be measured L2 includes transmitted light L21, which is irradiation light L1 transmitted straight through the object to be measured S, and scattered light L2, which is irradiation light L1 scattered by the object S. Such light to be measured L2 passes through the measurement window W, is emitted into the external space, and enters the lens system 221 of the light receiver 22. The lens system 221 guides the light to be measured L2 to the solid-state image sensor 222.

The solid-state image sensor 222 of the light receiver 22 outputs a detection signal of the light to be measured L2 based on the irradiation light L1 irradiated toward the object to be measured S. The solid-state image sensor 222 outputs a detection current or a detection voltage as the detection signal of the light to be measured L2. The intensity of the outputted detection signal corresponds to the optical intensity of the light to be measured L2 detected by the solid-state image sensor 222.

The controller 31 calculates the spatial distribution of the intensity of the light to be measured L2 at the light-receiving surface of the solid-state image sensor 222 based on the detection signal of the light to be measured L2. The controller 31 calculates the turbidity based on the calculated spatial distribution. Two examples of such a turbidity calculation method are described below.

(Turbidity Calculation Process)

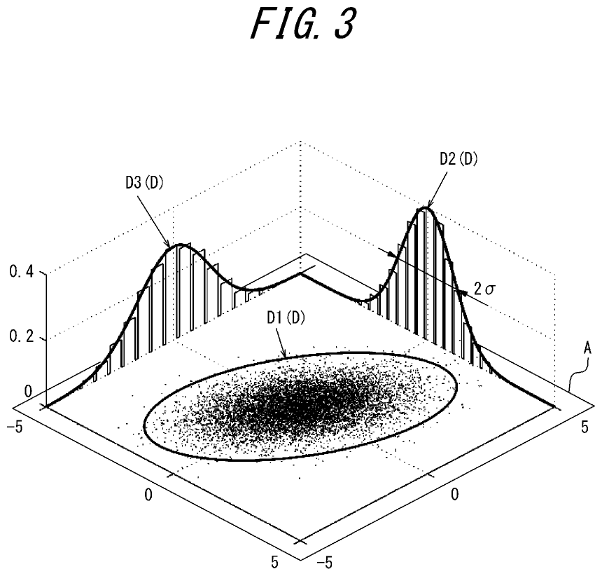

FIG. 3 is a schematic diagram illustrating a first example of a turbidity calculation process by the controller 31 in FIG. 1. FIG. 3 illustrates the spatial distribution D of the intensity of the light to be measured L2 at the light-receiving surface A of the solid-state image sensor 222 in FIG. 1. In FIG. 3, the two axes along the light-receiving surface A represent a Cartesian coordinate system for the spatial distribution D. The axis orthogonal to the light-receiving surface A corresponds to the intensity of the light to be measured L2. In FIG. 3, as an example, the size of the spatial distribution D and the size of the light-receiving surface A are substantially identical.

In the present specification, the “spatial distribution D” includes, for example, an intensity distribution D1 of the light to be measured L2 that is spread out in two dimensions on the light-receiving surface A, along with an intensity distribution D2 of the light to be measured L2 spread along one of two mutually orthogonal axes and an intensity distribution D3 of the light to be measured L2 spread along the other axis. The intensity distributions D2 and D3 are assumed to be normal distributions.

The controller 31 calculates the standard deviation σ of the intensity distribution D2 and/or the intensity distribution D3. The controller 31 determines the width of the spatial distribution D to be the standard deviation σ calculated for the intensity distribution D2 and/or the intensity distribution D3, which are normal distributions. For example, the controller 31 may determine the standard deviation σ calculated for the intensity distribution D2 or the intensity distribution D3 as the width of the spatial distribution D. For example, the controller 31 may determine the mean of the standard deviations σ calculated for both the intensity distribution D2 and the intensity distribution D3 as the width of the spatial distribution D. For example, the controller 31 may rotate the two mutually orthogonal axes around the peak position of the distribution in the spatial distribution D1 one rotation while maintaining the orthogonal relationship and calculate the standard deviation σ of both the intensity distribution D2 and the intensity distribution D3 for each rotation position. The controller 31 may determine the average of all standard deviations σ calculated in this way as the width of the spatial distribution D. The controller 31 calculates the turbidity based on the determined width of the spatial distribution D.

When the transparency of the object to be measured S is high and the turbidity is low, the proportion of scattered light among the light to be measured L2 decreases. Therefore, the light to be measured L2 is concentrated in the center of the light-receiving surface A of the light receiver 22. In other words, the standard deviation σ decreases, and the width of the spatial distribution D narrows. On the other hand, when the transparency of the object to be measured S is low and the turbidity is high, the proportion of scattered light among the light to be measured L2 increases. Therefore, the light to be measured L2 diffuses over a wide area of the light-receiving surface A of the light receiver 22. In other words, the standard deviation σ increases, and the width of the spatial distribution D widens.

A correlation can thus be seen between the width of the spatial distribution D and turbidity. In other words, the higher the turbidity, the greater the width of the spatial distribution D. The controller 31 may, for example, calculate the turbidity by multiplying the calculated value of the standard deviation σ by a predetermined coefficient of proportionality. The controller 31 may instead calculate the turbidity based on any linear function or any higher-order function with the value of the standard deviation σ as a parameter.

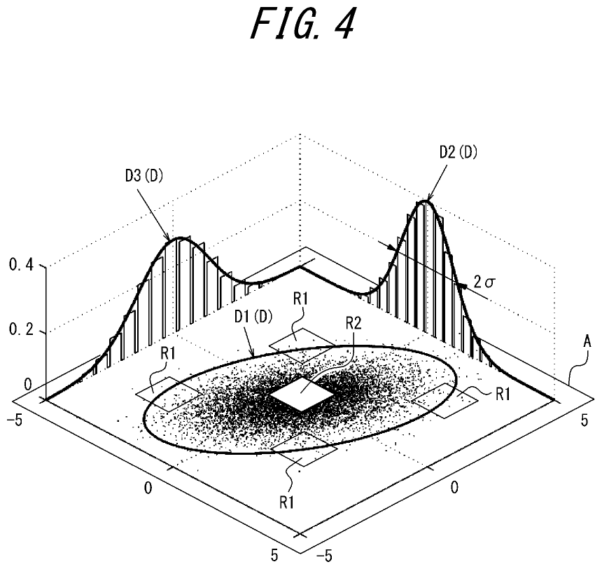

FIG. 4 is a schematic diagram illustrating a second example of a turbidity calculation process by the controller 31 in FIG. 1. The illustration in FIG. 4 is similar to that in FIG. 3, except for depicting a first region R1 and a second region R2, described below, for the spatial distribution D.

The controller 31 determines at least one first region R1 in which scattered light is detected in the spatial distribution D and at least one second region R2 in which transmitted light is detected in the spatial distribution D. The controller 31 determines the first region R1 and the second region R2 intended by the user based on input information, from the user, acquired from the input interface 33 of the turbidimeter 1 or input information, from the user, received from an external apparatus via the communication interface 35. In FIG. 4, the controller 31 determines the center of the spatial distribution D as the second region R2 and four corner regions separated from the center as first regions R1.

The controller 31 calculates the detected signal intensity of scattered light in Equation 1 based on the four determined first regions R1. For example, the controller 31 calculates the sum of the detected signal intensity of scattered light in the four first regions R1 as a detected signal intensity I_{S} of scattered light in Equation 1. This configuration is not limiting, and the controller 31 may calculate the average of the detected signal intensity of scattered light in the four first regions R1 as the detected signal intensity I_{S} of scattered light in Equation 1. Similarly, the controller 31 calculates the detected signal intensity of transmitted light in Equation 1 based on the determined second region R2. For example, the controller 31 calculates the detected signal intensity of transmitted light in the second region R2 as a detected signal intensity I_{T} of transmitted light in Equation 1.

The controller 31 calculates the ratio of the detected signal intensity I_{S} of the scattered light to the detected signal intensity I_{T} of the transmitted light based on the determined at least one first region R1 and second region R2. While using the above-described Equation 1, the controller 31 calculates the turbidity N from the calculated ratio of the detected signal intensity I_{S} of scattered light to the detected signal intensity I_{T} of transmitted light.

The turbidimeter 1 may perform either or both of the two turbidity calculation methods described using FIGS. 3 and 4.

(Additional Process)

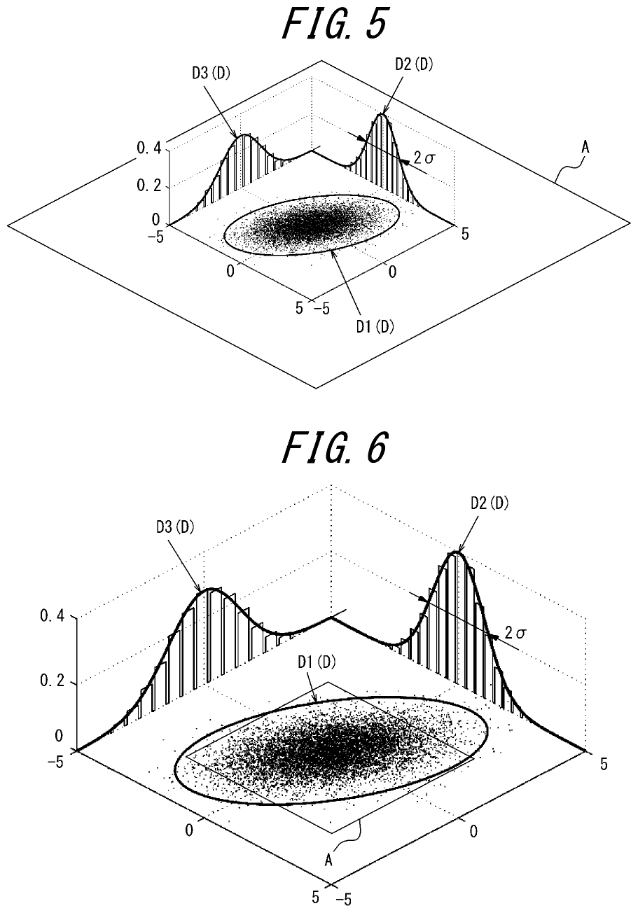

FIG. 5 is a first schematic diagram illustrating a first example of an additional process by the controller 31 in FIG. 1. FIG. 6 is a second schematic diagram illustrating the first example of an additional process by the controller 31 in FIG. 1. In addition to the above-described turbidity calculation process, the controller 31 may also use a zoom function, using the lens system 221 of the camera module as the light receiver 22, to change the magnification factor or reduction factor of the spatial distribution D on the light-receiving surface A according to the turbidity of the object to be measured S.

When the transparency of the object to be measured S is high and the turbidity is low, the light to be measured L2 is concentrated in the center of the light-receiving surface A of the light receiver 22. In other words, as illustrated in FIG. 5, the spatial distribution D is concentrated in the center of the light-receiving surface A and is smaller than the light-receiving surface A. When the spatial distribution D is smaller than the light-receiving surface A, the controller 31 may control the lens system 221 using the zoom function of the camera module to enlarge the spatial distribution D. For example, the controller 31 may enlarge the spatial distribution D so that the size of the spatial distribution D and the size of the light-receiving surface A become substantially identical, as illustrated in FIG. 3.

When the transparency of the object to be measured S is low and the turbidity is high, the light to be measured L2 also diffuses outside the light-receiving surface A of the light receiver 22. In other words, as illustrated in FIG. 6, the spatial distribution D is also present outside the light-receiving surface A and is larger than the light-receiving surface A. When the spatial distribution D is larger than the light-receiving surface A, the controller 31 may control the lens system 221 using the zoom function of the camera module to reduce the spatial distribution D. For example, the controller 31 may reduce the spatial distribution D so that the size of the spatial distribution D and the size of the light-receiving surface A become substantially identical, as illustrated in FIG. 3.

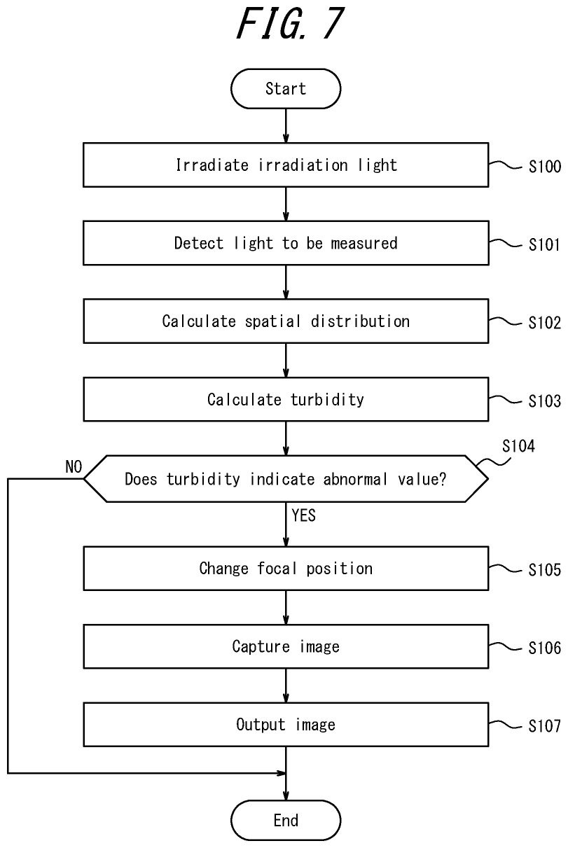

FIG. 7 is a flowchart illustrating a second example of an additional process by the controller 31 in FIG. 1. In addition to the above-described turbidity calculation process, the controller 31 may change the focal position of the lens system 221 as appropriate with a focus adjustment function that uses the lens system 221 of the camera module as the light receiver 22.

In step S100, the controller 31 uses the light source unit 21 to irradiate the irradiation light L1 towards the object to be measured S.

In step S101, the controller 31 detects the light to be measured L2 based on the irradiation light L1, irradiated towards the object to be measured S in step S100, using the solid-state image sensor 222. The light to be measured L2 includes transmitted light L21 and scattered light L22.

In step S102, the controller 31 calculates the spatial distribution D of the intensity of the light to be measured L2 on the light-receiving surface A of the solid-state image sensor 222 based on the detection signal of the light to be measured L2 outputted by the solid-state image sensor 222 in step S101.

In step S103, the controller 31 calculates the turbidity based on the spatial distribution D calculated in step S102.

In step S104, the controller 31 determines whether the turbidity calculated in step S103 indicates an abnormal value. The controller 31 determines, for example, that the calculated turbidity indicates an abnormal value when the turbidity exceeds a predetermined threshold. Upon determining that the turbidity indicates an abnormal value, the controller 31 performs the process in step S105. Upon determining that the turbidity does not indicate an abnormal value, i.e., that the turbidity is normal, the controller 31 ends the process.

In step S105, upon having determined in step S104 that the turbidity indicates an abnormal value, the controller 31 changes the focal position of the lens system 221 using the focus adjustment function of the camera module. The controller 31 controls the lens system 221 to focus on the surface of the second lens 212 on the side by the object to be measured S, the outer surface or inner surface of the measurement window W, or the interior of the object to be measured S.

During normal turbidity measurement, the controller 31 aligns the focal position of the lens system 221 with the surface of the second lens 212 on the side by the object to be measured S. Upon determining in step S104 that the turbidity indicates an abnormal value, the controller 31 may change the focal position to, for example, the outer surface or inner surface of the measurement window W on the light receiver 22 side or the interior of the object to be measured S. The controller 31 may freely select the position to which the focal position of the lens system 221 is changed or may select a position that conforms to user input information acquired from the input interface 33 or an external apparatus.

In step S106, the controller 31 performs the image capturing process using the camera module as the light receiver 22 at the focal position changed in step S105. In the present specification, an “image” includes, for example, a still image and/or a moving image.

In step S107, the controller 31 outputs the image captured in step S106. For example, the controller 31 displays the image on the display 34 of the turbidimeter 1. For example, the controller 31 transmits the image to an external apparatus via the communication interface 35 for the image to be displayed on a display of the external apparatus.

The turbidimeter 1 detects condensation on the measurement window W by focusing the lens system 221 on the outer surface of the measurement window W. Similarly, the user can recognize condensation on the measurement window W by viewing the image, outputted in step S107, in which the lens system 221 is focused on the outer surface of the measurement window W.

The turbidimeter 1 detects dirtiness on the measurement window W by focusing the lens system 221 on the inner surface of the measurement window W. Similarly, the user can recognize dirtiness on the measurement window W by viewing the image, outputted in step S107, in which the lens system 221 is focused on the inner surface of the measurement window W.

The turbidimeter 1 detects foreign matter, such as fallen leaves, flowing through the object to be measured S by focusing the lens system 221 on the interior of the object to be measured S. Similarly, the user can recognize foreign matter, such as fallen leaves, flowing through the object to be measured S by viewing the image, outputted in step S107, in which the lens system 221 is focused on the interior of the object to be measured S.

As described above, while using the focus adjustment function of the camera module, the controller 31 focuses the lens system 221 on a location that suits the purpose, thus enabling the user to observe different events.

As a third example of an additional process, in addition to the above-described turbidity calculation process, the controller 31 may illuminate the imaging target of the camera module as the light receiver 22 using the light source 223. During normal turbidity measurement, in which the focal position of the lens system 221 is aligned with the surface of the second lens 212 on the side by the object to be measured S, the controller 31 does not turn on the light source 223. The controller 31 may turn on the light source 223 when the focal position of the lens system 221 is changed to the outer surface or inner surface of the measurement window W or to the interior of the object to be measured S. At this time, the controller 31 may turn on or turn off the light source 211 of the light source unit 21.

For example, when the controller 31 focuses the lens system 221 on the outer surface of the measurement window W and detects condensation on the measurement window W, the controller 31 may turn on the light source 223 to improve visibility in backlight. For example, when the controller 31 focuses the lens system 221 on the inner surface of the measurement window W and detects dirtiness on the measurement window W, the controller 31 may turn on the light source 223 to improve visibility in backlight. For example, when the controller 31 focuses the lens system 221 on the interior of the object to be measured S and detects foreign matter inside the object to be measured S, and the amount of light from the light source 211 during image capture by the camera module is insufficient, the controller 31 may turn on the light source 223 in addition to the light source 211 to increase the amount of light.

(Effects)

According to the turbidimeter 1 in an embodiment as described above, the accuracy of turbidity measurement can be improved. By the light receiver 22 including the solid-state image sensor 222, the turbidimeter 1 can perform turbidity measurements using the equivalent of tens of thousands to millions or more of light-receiving elements as compared to conventional turbidimeters that have transmitted light detectors and scattered light detectors discretely arranged and that use only several light-receiving elements. Since the gap between light-receiving elements is extremely reduced in the turbidimeter 1, the percentage of light to be measured L2 that is directed to the gap between light-receiving elements and not detected is greatly reduced. In other words, it is possible to detect substantially all of the light to be measured L2 that is continuously spread out. The turbidimeter 1 can accurately calculate the spatial distribution D of the intensity of the light to be measured L2 on the light-receiving surface A of the solid-state image sensor 222. Consequently, the turbidimeter 1 can perform more accurate turbidity measurements.

By calculating the turbidity based on the width of the spatial distribution D of the intensity of the light to be measured L2 that spreads continuously on the light-receiving surface A, the turbidimeter 1 can measure the turbidity while using all of the detection information of the light to be measured L2 that spreads out on the light-receiving surface A. Accordingly, the turbidimeter 1 can perform more accurate turbidity measurements.

The turbidimeter 1 calculates the turbidity by calculating the ratio of the detected signal intensity of the scattered light L22 to the detected signal intensity of the transmitted light L21 based on at least one first region R1 and second region R2. The turbidimeter 1 can thus calculate the turbidity in the same way as a conventional turbidimeter. Accordingly, the user can easily compare the results of turbidity measurements using the turbidimeter 1 with the results of turbidity measurements using a conventional turbidimeter, such as one that discretely detects the light to be measured using several light-receiving elements.

In addition, in conventional turbidimeters, it is necessary to change the arrangement of a plurality of scattered light detectors for each turbidity measurement of the object to be measured. The user's empirical knowledge is highly necessary to determine how to arrange the plurality of multiple scattered light detectors. This results in a large workload for changing the arrangement of the plurality of scattered light detectors. Since the turbidimeter 1 uses the solid-state image sensor 222, which has tens of thousands to millions or more of light-receiving elements, the user does not need to change the arrangement of the light-receiving elements and can perform different turbidity measurements easily by simply changing the first region R1 on the solid-state image sensor 222. In the turbidimeter 1, the degree of freedom regarding the selection of the detection region of the scattered light L22 is greatly improved compared to conventional technology. For example, the user can easily perform turbidity measurements of various objects to be measured S by simply selecting the first region R1 using the input interface 33 of the turbidimeter 1 or an external apparatus that is communicably connected to the communication interface 35.

By the light receiver 22 including the lens system 221, the turbidimeter 1 can direct the light to be measured L2, which is diffused from the object to be measured S and is incident on the light receiver 22, to the solid-state image sensor 222 without any leakage. In addition, with the lens system 221, the turbidimeter 1 can provide a focus adjustment function and/or a zoom function to the camera module as the light receiver 22.

The turbidimeter 1 controls the lens system 221 to focus on the surface of the second lens 212 on the side by the object to be measured S, the outer surface or inner surface of the measurement window W, or the interior of the object to be measured S and can thereby capture different events using the focus adjustment function of the camera module. By viewing images focused on various locations, users can observe the event that meets their objective. Users can observe each event in real time based on images outputted by real-time imaging.

For example, the turbidimeter 1 can detect condensation on the measurement window W by focusing the lens system 221 on the outer surface of the measurement window W. By also using the zoom function of the camera module as the light receiver 22, the user can easily recognize even fine condensation that cannot be confirmed visually. For example, the user can easily recognize fine condensation on the order of micrometers.

For example, the turbidimeter 1 can detect dirtiness on the measurement window W by focusing the lens system 221 on the inner surface of the measurement window W. By also using the zoom function of the camera module as the light receiver 22, the user can easily recognize even slight dirtiness that cannot be confirmed visually.

For example, the turbidimeter 1 can detect foreign matter, such as fallen leaves, flowing through the object to be measured S by focusing the lens system 221 on the interior of the object to be measured S. In addition, the turbidimeter 1 can also detect bubbles and the like that form in the object to be measured S. By also using the zoom function of the camera module as the light receiver 22, the user can easily recognize even small foreign matter and small bubbles that cannot be confirmed visually. For example, the user can easily recognize small bubbles on the order of micrometers. Furthermore, by using the light source 223 of the light receiver 22 in addition to the focus adjustment and zoom functions, the user can easily recognize the scattering of small foreign matter such as metal fragments on the order of micrometers.

Conversely, the user can also easily recognize large objects that are present in object to be measured S. For example, the user can monitor fish swimming in measurement water as the object to be measured S in order to control the water quality of an aquarium in which the user keeps fish and other animals.

For example, the turbidimeter 1 can focus the lens system 221 on the interior of the object to be measured S and use a high-speed imaging camera module as the light receiver 22 to capture images with even higher detection sensitivity. This enables the user to more accurately recognize critical foreign matter, which could lead to equipment damage, by means of slow-motion images. In a case in which real-time monitoring reveals critical foreign matter that could lead to equipment damage, the user can immediately stop operation of the equipment. For example, the user can monitor and detect, in real time, metal powder and other foreign matter, bubbles, cavitation, and the like, which can lead to turbine damage in pumps and the like operating in the plant.

When the turbidity indicates an abnormal value, the user and the turbidimeter 1 can quickly determine that the cause is, for example, either or both of condensation on the outer surface of the measurement window W and dirtiness on the inner surface of the measurement window W. In other words, the user and the turbidimeter 1 can accurately and quickly ascertain the cause of the abnormal turbidity value. Similarly, even in a case in which the turbidity calculated by turbidimeter 1 indicates an instantaneous abnormal value due to foreign matter such as fallen leaves flowing in the object to be measured S, the user and the turbidimeter 1 can accurately and quickly recognize the cause of the instantaneous abnormal turbidity value.

The user can accurately and quickly recognize the cause of an abnormality in the turbidity value while viewing the image displayed on the display 34 of the turbidimeter 1 or on an external apparatus that is communicably connected to the communication interface 35. The user can also view the images at a distance from the location where the turbidimeter 1 is installed while using the external apparatus as a remote monitor. If a large monitor is used as a remote monitor, the images can be viewed by an unspecified number of users. If a portable terminal is used as the external apparatus, the user can view the images in real time regardless of location.

In this way, the user can investigate the cause of the abnormal turbidity value without needing to visit the site where the turbidimeter 1 is installed and disassemble the turbidimeter 1 to check the inside of the turbidimeter 1. This facilitates inspection of the turbidimeter 1 by the user.

By controlling the lens system 221 to enlarge the spatial distribution D when the spatial distribution D is smaller than the photosensitive area A, the turbidimeter 1 can always detect the light to be measured L2 with the maximum resolution by using the magnification function of the camera module. Accordingly, the turbidimeter 1 can further improve the accuracy of turbidity measurement.

By controlling the lens system 221 to reduce the spatial distribution D when the spatial distribution D is larger than the photosensitive area A, the turbidimeter 1 can always detect the light to be measured L2 with the maximum resolution by using the reduction function of the camera module. Accordingly, the turbidimeter 1 can further improve the accuracy of turbidity measurement.

As a result of the light receiver 22 including the light source 223 that illuminates the object to be imaged by the solid-state image sensor 222, the turbidimeter 1 can also cause the light source 223 to function as a strobe light source for a camera. Accordingly, the turbidimeter 1 can also use the light source 223 to increase the amount of light in a case in which the amount of light of the light source 211 is insufficient during image capture by a camera module as the light receiver 22. Similarly, the turbidimeter 1 can also use the light source 223 to improve visibility in backlight.

(Modifications)

Although the present disclosure is based on embodiments and drawings, it is to be noted that various changes and modifications will be apparent to those skilled in the art based on the present disclosure. Therefore, such changes and modifications are to be understood as included within the scope of the present disclosure. For example, the functions and the like included in the various configurations and steps may be reordered in any logically consistent way. Furthermore, components or steps may be combined into one or divided.

For example, the present disclosure may also be embodied as a program containing a description of the processing for achieving the functions of the above-described turbidimeter 1 or a recording medium with the program recorded thereon. Such embodiments are also to be understood as falling within the scope of the present disclosure.

For example, the shape, arrangement, orientation, and number of the above-described components are not limited to the above explanation or the drawings. The shape, arrangement, orientation, and number of each component may be selected freely as long as the functions of the component can be achieved.

In the above embodiment, the controller 31 has been described as determining the width of the spatial distribution D based on the standard deviation σ of the intensity distribution D2 and/or the intensity distribution D3, but this configuration is not limiting. The controller 31 may directly determine the width of the spatial distribution D based on the intensity distribution D1 on a two-dimensional plane.

In the above embodiment, the controller 31 has been described as determining the center of the spatial distribution D as the second region R2 and four corner regions separated from the center as first regions R1, but this configuration is not limiting. The controller 31 may determine any number of first regions R1 at any positions on the spatial distribution D. In the above embodiment, the controller 31 has been described as determining the first region R1 and the second region R2 based on the intensity distribution D1 in the spatial distribution D, but this configuration is not limiting. The controller 31 may determine the first region R1 and the second region R2 based on the intensity distribution D2 and/or the intensity distribution D3 in the spatial distribution D.

In the above embodiment, the spatial distribution D is assumed to be a normal distribution, but this configuration is not limiting. The spatial distribution D may include any distribution in accordance with the actual distribution of the light to be measured L2 incident on the light-receiving surface A while diffusing from the object to be measured S.

In the above embodiment, the light receiver 22 has been described as including the lens system 221, but this configuration is not limiting. In the turbidimeter 1, the light receiver 22 need not include the lens system 221, as long as the light to be measured L2 from the object to be measured S can be accurately guided to the solid-state image sensor 222 and neither the focus adjustment function nor the zoom function is required. Alternatively, the turbidimeter 1 may have the lens system 221 as a separate configuration not included in the light receiver 22. That is, the lens system 221 may be located outside of the light receiver 22, between the measurement window W and the light receiver 22.

In the above embodiment, the controller 31 has been described as controlling the lens system 221 to focus on the surface of the second lens 212 on the side by the object to be measured S, the outer surface or inner surface of the measurement window W, or the interior of the object to be measured S, but this configuration is not limiting. The controller 31 may focus on any position in the optical module 2 using the focus adjustment function of a camera module as the light receiver 22. On the other hand, the controller 31 may fix the focal position to the surface of the second lens 212 on the side of the object to be measured S, without performing such a focus adjustment process.

In the above embodiment, upon having determined that the turbidity indicates an abnormal value, the controller 31 has been described as changing the focal position of the lens system 221 using the focus adjustment function of the camera module, but this configuration is not limiting. By the lens system 221 including a plurality of optical systems such that a plurality of locations in the optical module 2 is in focus, the controller 31 may acquire images at the plurality of locations simultaneously and stored the images as image information in the memory 32. The controller 31 may store the images at the plurality of locations as image information in the memory 32 continuously, periodically or non-periodically, or only when the turbidity indicates an abnormal value.

This enables the user to easily investigate the cause of the turbidity indicating an abnormal value based on past images stored in the memory 32. For example, the user can easily investigate the cause of the turbidity indicating an abnormal value by replaying each of the images, at a plurality of locations, captured at times corresponding to the times when the turbidity indicates an abnormal value. The user can easily determine that the cause for the turbidity indicating an abnormal value is, for example, either or both of condensation on the outer surface of the measurement window W and dirtiness on the inner surface of the measurement window W by reviewing past images. The user can easily determine that the cause for the turbidity indicating an abnormal value is, for example, foreign matter such as fallen leaves flowing in the object to be measured S by reviewing past images.

In the above embodiment, the controller 31 has been described as controlling the lens system 221 to enlarge the spatial distribution D when the spatial distribution D is smaller than the light-receiving surface A, but this configuration is not limiting. The controller 31 need not perform such an enlargement process.

In the above embodiment, the controller 31 has been described as controlling the lens system 221 to reduce the spatial distribution D when the spatial distribution D is larger than the light-receiving surface A, but this configuration is not limiting. The controller 31 need not perform such a reduction process.

In the above embodiment, the light receiver 22 has been described as including the light source 223 that illuminates the object to be imaged by the solid-state image sensor 222, but this configuration is not limiting. The light receiver 22 need not include such a light source 223. In the above embodiment, the controller 31 has been described as not turning on the light source 223 during normal turbidity measurement, in which the focal position of the lens system 221 is aligned with the surface of the second lens 212 on the side by the object to be measured S, but this configuration is not limiting. Instead of or in addition to the light source 211 of the light source unit 21, the controller 31 may turn on the light source 223 of the light receiver 22. When the controller 31 turns on the light source 223 instead of the light source 211, the light source unit 21 for realizing the function of turbidity measurement may include the light source 223 instead of the light source 211. In other words, the turbidimeter 1 may perform turbidity measurement using the light source 223.

The controller 31 may perform at least one of the aforementioned processes described in the first, second, and third examples of additional processes or may refrain from performing any of them.

In the above embodiment, the light source 211 of the light source unit 21 has been described as including a lamp light source, for example, but this configuration is not limiting. The light source 211 may include any other light source capable of realizing turbidity measurement. For example, the light source 211 may include an LED having an emission spectrum similar to the emission spectrum of a lamp light source.

In the present embodiment, the second lens 212 of the light source unit 21 has been described as including, for example, a condensing lens, but this configuration is not limiting. The second lens 212 may include any other lens capable of realizing turbidity measurement. Alternatively, the second lens 212 may be omitted as long as the turbidimeter 1 is capable of performing turbidity measurement.

In the above embodiment, the solid-state image sensor 222 has been described as including a CCD, for example, but this configuration is not limiting. The solid-state image sensor 222 may include any other image sensor configured by elements, ranging in number from tens of thousands to millions or more, capable of detecting light and integrated on a small chip. For example, the solid-state image sensor 222 may include a Complementary Metal-Oxide Semiconductor (CMOS).

In the above embodiment, the light source 223 of the light receiver 22 has been described as including an LED, for example, but this configuration is not limiting. The light source 223 may include any other light source that functions as a strobe light source for the camera. For example, the light source 223 may include a lamp light source.

In the above embodiment, the turbidimeter 1 has been described as having one camera module as the light receiver 22, but this configuration is not limiting. Apart from the camera module for turbidity measurement, the turbidimeter 1 may additionally have at least one dedicated camera module, at any position, for monitoring another location such as the measurement window W.

In the above embodiment, the turbidimeter 1 has been described as using a transmitted/scattered light comparison method, but this configuration is not limiting. The turbidimeter 1 may calculate the turbidity of the object to be measured S by detecting right-angle scattered light from the object to be measured S using the light receiver 22 positioned at 90 degrees relative to the light source unit 21. Alternatively, the turbidimeter 1 may have the functions of both the transmitted/scattered light comparison method and the right-angle scattered light method and be configured to switch between the two methods as appropriate. In this case, turbidimeter 1 may have a plurality of camera modules as the light receiver 22.

In the above embodiment, turbidimeter 1 has been described as measuring only the turbidity of the object to be measured S, but this configuration is not limiting. The turbidimeter 1 may be configured to measure the chromaticity in addition to the turbidity of the object to be measured S.

In this case, the solid-state image sensor 222 of the light receiver 22 may include a color CCD. The color CCD may, for example, have a light-receiving band in the visible light region, or the light-receiving band may extend to the ultraviolet region and/or the infrared region in addition to the visible light region.

The light source 211 of the light source unit 21 may include any light source that can switch the central wavelength of the emission spectrum among a plurality wavelengths in the visible light region. For example, the light source 211 may include a plurality of LEDs with different central wavelengths from each other in narrow bandwidths, or the light source 211 may include a light source that combines a wide band LED that encompasses the entire visible light region with a narrow band wavelength-variable bandpass filter.

The controller 31 measures the chromaticity of the object to be measured S by switching the central wavelength of the optical spectrum of the irradiation light L1 irradiated from the light source 211 to a plurality of wavelengths defined as necessary for the measurement of chromaticity.

In a conventional chromaticity meter, chromaticity measurement is performed by using a drive mechanism to switch optical filters that transmit different wavelengths of light. Unlike a conventional configuration, the turbidimeter 1 does not require expensive mechanical optical rotating filters, lenses, switching circuits, and the like and can be manufactured inexpensively with a simple configuration. Since the number of consumable parts is greatly reduced in the turbidimeter 1, the durability and reliability of the product are improved.

By being capable also of measuring the chromaticity of the object to be measured S, the turbidimeter 1 can monitor not only the turbidity of the object S, but also its hue. The turbidimeter 1 can monitor the hue of the object to be measured S in real time. For example, the turbidimeter 1 can monitor the hue in addition to the appearance of bubbles corresponding to the degree of carbonation of a soft drink. In this case, the object to be measured S includes soft drinks. Other objects to be measured S may include condiments, such as soy sauce and dressings; alcoholic beverages, such as wine, sake, and whiskey; and coating materials, such as ink, paint, and India ink. Furthermore, the turbidimeter 1 may monitor the degree of contamination of fuels, such as gasoline and oil, and the degree of metal powder contamination and degradation of lubricating oils and the like.

The object to be measured S may contain solids as well as liquids. For example, the turbidimeter 1 may monitor the hue of glass products. Furthermore, if the turbidimeter 1 is designed to be heat resistant, the turbidimeter 1 can also monitor high-temperature molten glass in real time. The turbidimeter 1 can also monitor the degree of transparency of transparent glass, such as household glass, rather than colored glass.

The object to be measured S is not limited to liquids and solids and may also contain gases. For example, the turbidimeter 1 can also monitor colored gases.

1. A turbidimeter for measuring turbidity of an object to be measured, the turbidimeter comprising:
a light source configured to irradiate an irradiation light towards the object to be measured;
a light receiver comprising a solid-state image sensor configured to output a detection signal of light to be measured that includes transmitted light and scattered light based on the irradiation light irradiated towards the object to be measured; and
a controller configured to calculate a spatial distribution of intensity of the light to be measured on a light-receiving surface of the solid-state image sensor based on a detection signal of the light to be measured and calculate the turbidity based on the calculated spatial distribution.

2. The turbidimeter according to claim 1, wherein the controller is configured to calculate the turbidity based on a width of the spatial distribution.

3. The turbidimeter according to claim 1, wherein the controller is configured to calculate a ratio of detected signal intensity of the scattered light to detected signal intensity of the transmitted light based on at least one first region in which the scattered light is detected in the spatial distribution and a second region in which the transmitted light is detected in the spatial distribution.

4. The turbidimeter according to claim 1, wherein the light receiver comprises a lens system that includes at least one first lens and directs the light to be measured to the solid-state image sensor.

5. The turbidimeter according to claim 4, wherein
the light source includes a second lens that directs the irradiation light to a region in which the object to be measured is located, through a measurement window separating the region from outside space, and that collimates the irradiation light, and
the controller is configured to control the lens system to focus on a surface of the second lens on a side by the object to be measured, an outer surface or inner surface of the measurement window, or an interior of the object to be measured.

6. The turbidimeter according to claim 4, wherein the controller is configured to control the lens system to enlarge the spatial distribution when the spatial distribution is smaller than the light-receiving surface.

7. The turbidimeter according to claim 4, wherein the controller is configured to control the lens system to reduce the spatial distribution when the spatial distribution is larger than the light-receiving surface.

8. The turbidimeter according to claim 1, wherein the light receiver comprises a light source configured to illuminate an object to be imaged by the solid-state image sensor with light.

9. The turbidimeter according to claim 1, wherein the solid-state image sensor comprises a color CCD.

10. A turbidity measurement method for measuring turbidity of an object to be measured, the turbidity measurement method comprising:
irradiating an irradiation light towards the object to be measured;
using a solid-state image sensor to detect light to be measured that includes transmitted light and scattered light based on the irradiation light irradiated towards the object to be measured;
calculating a spatial distribution of intensity of the light to be measured on a light-receiving surface of the solid-state image sensor based on a detection signal of the light to be measured; and
calculating the turbidity based on the calculated spatial distribution.
